(19) United States
(12) Patent Application Publication
(10) Pub. No.: US 2005/0141511 A1
(43) Pub. Date: Jun. 30, 2005

(54) Method of reducing call setup time for IP services in a mobile communication network

(76) Inventor: Thawatt Gopal, San Diego, CA (US)

Correspondence Address: COATS & BENNETT, PLLC, P O BOX 5, RALEIGH, NC, 27602, US

(21) Appl. No.: 11/005,811

(22) Filed: Dec. 7, 2004

Related U.S. Application Data
(60) Provisional application No. 60/527,995, filed on Dec. 8, 2003.

(51) Int. Cl. H04L 12/56

(52) U.S. Cl. 370/395.2

(57) ABSTRACT

To initiate a communication session between a mobile station and an application server, the mobile station sends a reconnect message to a base station to reestablish a communication channel for a dormant packet data session. The reconnect message includes an encapsulated call control message to said application server. The base station extracts the call control message from the reconnect message and forwards the call control message towards the application server, while proceeding to reestablish a communication channel with the mobile station.

### RELATED APPLICATIONS

This application claims priority under 35 U.S.C. § 119(e) from U.S. provisional application Ser. No. 60/527,995 filed on 8 Dec. 2003, which is expressly incorporated in its entirety by reference herein.

### BACKGROUND OF THE INVENTION

The present invention relates generally to mobile communication networks providing packet data services to mobile stations, and more particularly, to a method of reducing call setup time for IP-based multimedia services.

Cellular networks were originally developed to provide primarily voice services over circuit-switched networks. Although circuit-switched networks are still in widespread use, the current trend is toward packet-switched networks that provide not only voice services, but also high speed packet data services that enable mobile users to surf the web, read e-mail, download video and audio files, and do the other things that Internet users can do on fixed networks.

Because voice traffic tends to be symmetric and does not tolerate excessive latency, traditional circuit-swtiched networks dedicate a physical channel to a mobile station for the duration of a voice call. The physical channel assigned to one mobile station cannot be used by another mobile station until the call ends and the resources are released by the mobile station assigned to the channel. Data traffic, in contrast, tends to be asymmetric and is more tolerant to latency. Furthermore, there may be long periods when a mobile station is neither sending nor receiving packet data. During such periods of inactivity, the resources allocated to the mobile station are not being used. Therefore, in packet data networks, system capacity can be increased by reassigning unused radio resources to another user when a mobile station is inactive for a long period of time.

In packet data systems, the mobile station establishes a connection with a packet core network during initial call set up. After a period of inactivity, the packet data session transitions to a dormant state and the radio resources establishing a radio link between the mobile station and base station are released while the connection with the packet core network is maintained. When the mobile station needs to transmit data to the network or vice versa, the mobile station must reestablish a radio link to the base station to transmit or receive data. The procedure for establishing or reestablishing a call is referred to as call set up.

In a typical packet data session, a call may be set up and torn down repeatedly during a single packet data session. The necessity of setting up a channel to reestablish a dormant packet data session introduces some latency. As earlier noted, many packet data applications can tolerate some delay in setting up a call. For example, when a user is web browsing, the user may click on a link to request download of a new web page. Some delay in receiving the web page is expected and does not detract significantly from the user's experience or perceptions about the quality of service. Other applications may be less tolerant of delay.

Push-to-talk (PTT) is an example of an application that is less tolerant of delay. PTT is a half-duplex voice service wherein users press and hold a key when they speak, similar to a walkie talkie. Unlike regular voice calls, which are full duplex, PTT allows only one user to speak at a time. A user requests the “floor” by pressing a PTT key and maintains control of the floor once obtained by holding the PTT key. The delay between the time that the user requests the floor by pressing the PTT key and the time that the user receives confirmation that control of the floor has been obtained contributes significantly to the user's perception of quality.

While packet data communications are generally tolerant to delays, reduction in call set up latency can serve to enhance perceived quality of service from a user viewpoint.

### SUMMARY OF THE INVENTION

The present invention provides a method for initiating a communication session between a mobile station and an application server, such as a push-to-talk server. The method of the present invention may be used, for example, when the mobile station has a dormant packet data session with the mobile network. While the packet data session is dormant, the mobile station maintains a connection with a packet data serving node (PDSN), but does not have a dedicated communication channel for communications with the mobile network. The mobile station can reestablish a communication channel by sending a reconnect message to the mobile network. The mobile station may embed or encapsulate a call control message to an application server to initiate a communication session with the application server within the reconnect message. The reconnect message with the encapsulated call control message is transmitted to a base station over a random access channel, which in cdma2000 systems can be either the Reverse Access Channel (R-ACH) or the Reverse Enhanced Access Channel (R-EACH).

In one embodiment, the call control signal is contained within a short data burst. The reconnect message includes a burst indicator flag indicating the presence of a short data burst in the reconnect message. The base station receiving the reconnect message extracts the call control message and forwards it toward the application server. The base station then reestablishes a communication channel with a mobile station to enable communications between the mobile station and mobile network.

The session initiation procedure according to the present invention reduces the amount of time needed to set up a communication session with the application server by enabling parallel set up of the traffic channel and end-to-end session with the application server. Further, the present invention reduces the number of messages that need to be transmitted over the random access channel for sending initiation. The present invention may be used, for example, to establish a push-to-talk session, to establish a VoIP call, and many other IP services.

### BRIEF DESCRIPTION OF THE DRAWINGS

FIG. 1 is a block diagram illustrating a mobile communication network in which the present invention may be implemented including a radio access network, core network, and IP core network.

FIG. 2 is a block diagram illustrating components of the radio access network, core network, and IP core network according to one embodiment of the present invention.

FIG. 3 is a block diagram of a base station in the radio access network according to one embodiment of the present invention.

FIG. 4 is a block diagram of a mobile station according to one embodiment of the present invention.

FIG. 5 is a call flow chart illustrating a conventional method of establishing a communication session with an application server.

FIG. 6 is a call flow chart illustrating a method according to the present invention of establishing a communication session with an application server.

FIG. 7 illustrates the elements of a reconnect message according to one embodiment of the present invention.

### DETAILED DESCRIPTION OF THE INVENTION

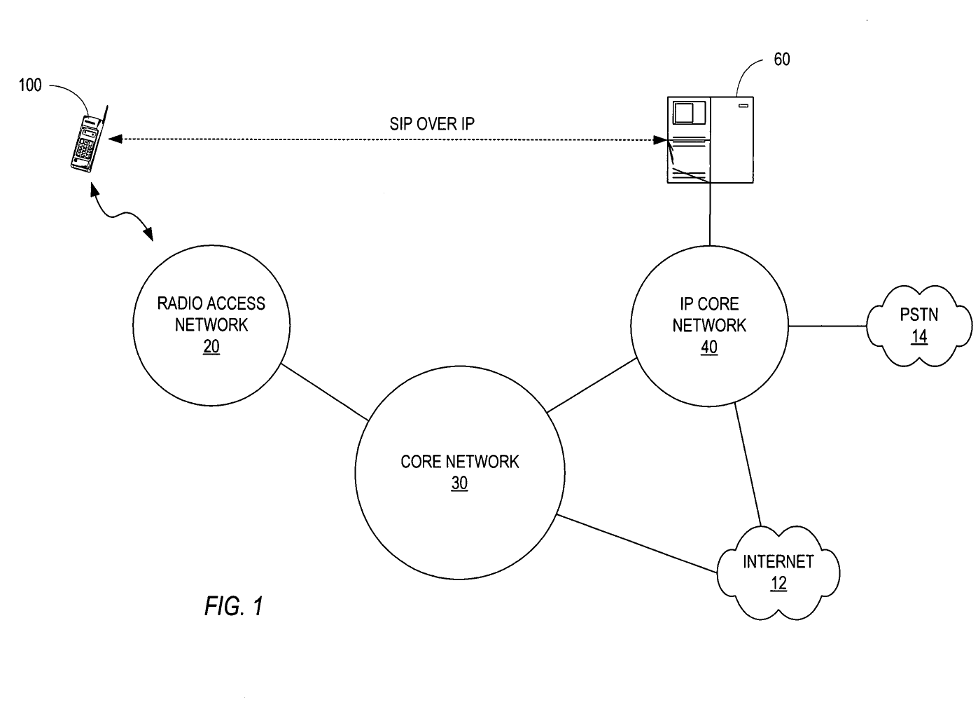

FIG. 1 illustrates a mobile communication network 10 in which the present invention may be employed. The mobile communication network 10 comprises a radio access network (RAN) 20, a core network (CN) 30, and an IP Core Network 40. The RAN 20 supports radio communications with mobile terminals 100 over an air interface. The mobile communication network 10 typically includes more than one RAN 20 though only one is shown in FIG. 1. The CN 30 provides a connection to the Internet 12 or other packet data network (PDN) for packet switched services such as web browsing and email and may provide a connection to the Public Switched Telephone Network (PSTN) 14 and/or the Integrated Digital Services Network (ISDN) 16 for circuit-switched services such as voice and fax services. The CN 30 may, for example, comprise a cdma2000, WCDMA or UMTS network. The CN 30 interconnects with the IP core network 40. The IP core network 40 provides access independent, IP-based multi-media services to mobile terminals 100 and supports a variety of IP services including voice over IP (VoIP), video and audio streaming, email, web browsing, videoconferencing, instant messaging, presence and other services. An example of an IP core network 40 is the IP Multimedia Subsystem (IMS). The IP core network enables the mobile station 100 to communicate with an application server 60 using SIP or other session control protocol over IP.

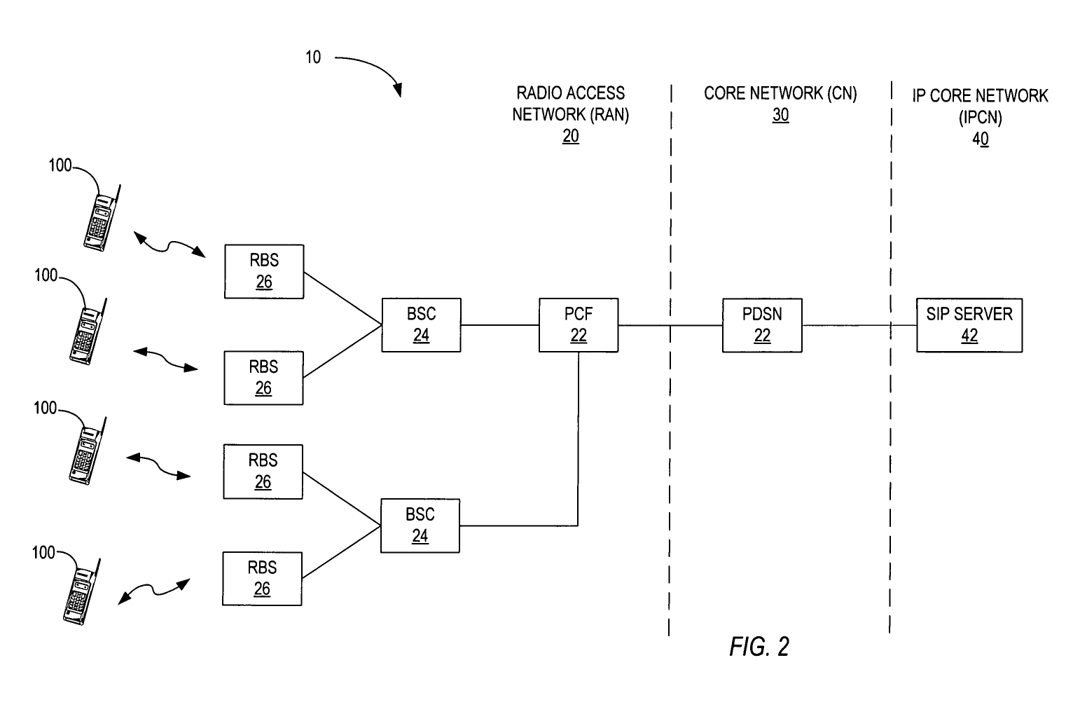

FIG. 2 illustrates some of the components of the RAN 20, CN 30, and IP core network 40. RAN 20 includes a Packet Control Function (PCF) 22, one or more Base Station Controllers (BSCs) 24 and one or more radio base stations (RBSs) 26. The primary function of the PCF 22 is to establish, maintain, and terminate connections to the PDSN 32, and manages the buffering and relaying of data packets between the BSC 24 and PDSN 32. The BSCs 24 manage the radio resources within their respective coverage areas. The RBSs 26 include the radio equipment for communicating over the air interface with mobile stations 12. A BSC 24 can manage more than one RBSs 26. In cdma2000 networks, a BSC 24 and an RBS 26 comprise a base station 50 (FIG. 2), which is described in more detail below. The BSC 24 is the control part of the base station 50. The RBS 26 is the part of the base station 50 that includes the radio equipment and is normally associated with a cell site. In cdma2000 networks, a single BSC 24 may comprise the control part of multiple base stations 50. In other network architectures based on other standards, the network components comprising the base station 50 may be different but the overall functionality will be the same or similar.

The core network 30 includes a Packet Data Serving Node (PDSN) 32 and an access gateway connecting to the IP core network 40. The PDSN 32 supports PPP connections to and from the mobile station 12 and manages the radio-packet (R-P) interface. The PDSN 32 may function as a foreign agent to provide routing services to mobile stations according to simple IP and/or mobile IP protocols. The PDSN 32 also initiates authentication, authorization and accounting for the mobile station to an AAA server.

The IP core network 40 includes one or more SIP servers 42, which may function as SIP proxy servers or SIP registrar servers. In the IMS, SIP servers are referred to as a Call Session Control Functions (CSCFs). The CSCFs 42 function as SIP servers to process session control signaling used to establish, modify and terminate a communication session. Functions performed by the CSCFs 42 include call control, address translation, authentication, capability negotiation, and subscriber profile management. A Proxy CSCF (P-CSCF) functions as a SIP proxy server. A Serving CSCF (S-CSCF) functions as the SIP registrar server. The mobile station 100 registers its location with a SIP registrar, such as a S-CSCF, which are often co-located with a SIP proxy server. All signaling traffic between the mobile station 100 and application server 60 traverses the SIP registrar server. The SIP proxy server is an intermediate server that receives SIP requests from a client and then forwards the requests on the client's behalf.

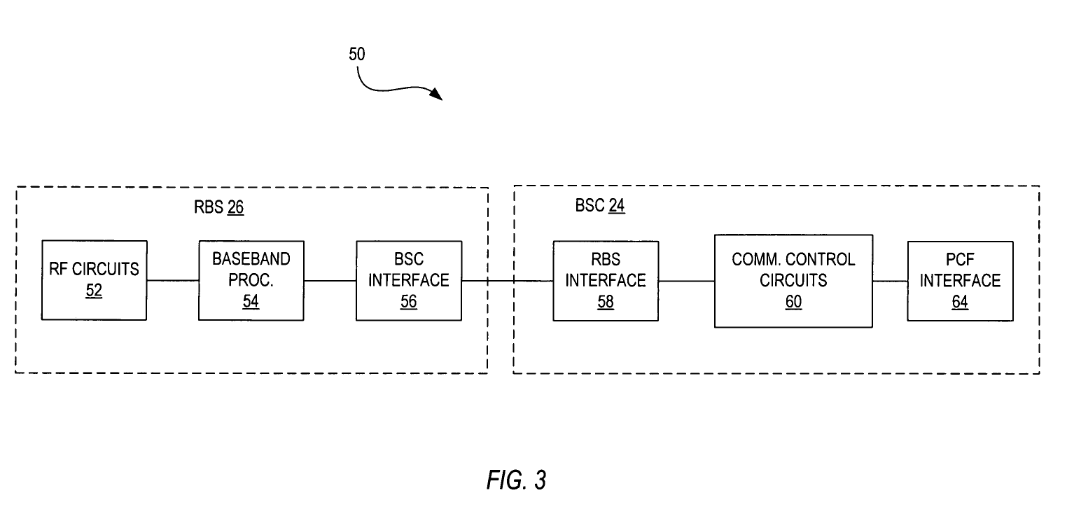

FIG. 3 illustrates exemplary details of a base station 50 in a cdma2000 network. The base station components in the exemplary embodiment are distributed between a RBS 26 and a BSC 24. The RBS 26 includes RF circuits 52, baseband processing circuits 54, and interface circuits 56 for communicating with the BSC 24. The BSC 24 includes interface circuits 58 for communicating with the RBS 26, communication control circuits 60, and interface circuits 64 for communicating with the PCF 32. The communication control circuits 60 manage the radio and communication resources used by the base station 40.

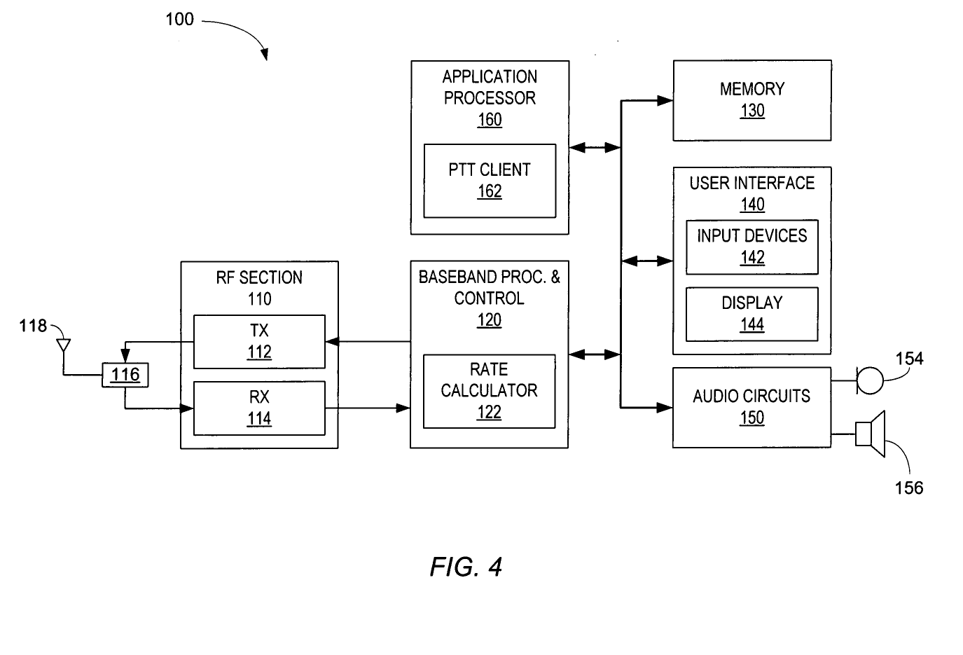

FIG. 4 illustrates details of an exemplary mobile station 100. The mobile station 100 includes an RF section 110, baseband processing and control circuits 120, memory 130, user interface 140, audio circuits 150, and an application processor 160. RF section 110 provides a radio interface for communicating with a base station. The RF section 110 comprises a transmitter 112 and receiver 114 coupled to a shared antenna 118 through an RF switch 116. Transmitter 112 modulates transmitted signals onto an RF carrier and amplifies the transmit signal for transmission to a base station. Receiver 114 filters, amplifies, and downconverts received signals to baseband for processing by the baseband processing and control circuits 120. The baseband processing and control circuits 120 perform baseband processing for signals transmitted from, and received by, the mobile station, and control the overall operation of the mobile station. The baseband processing and control circuits 120 may comprise one or more processors, hardware, firmware, or a combination thereof. The baseband processing and control circuits 120 include a signaling processor 122 that performs signaling tasks required by applicable standards. As will be described in greater detail below, the signaling tasks performed by the signaling processor 122 include rate control signaling.

Memory 130 stores programs and data used by the baseband processing and control circuits 120. Memory 130 may also store user applications, such as a PTT client application enabling PTT functionality. Memory 130 may comprise one or more memory devices and may include both random access memory (RAM) and read-only memory (ROM). Computer programs and data required for operation of the device are stored in non-volatile memory, such as EPROM, EEPROM, and/or flash memory. The memory devices may be implemented as discrete devices, stacked devices, or integrated with processors in the baseband processing and control circuits 120.

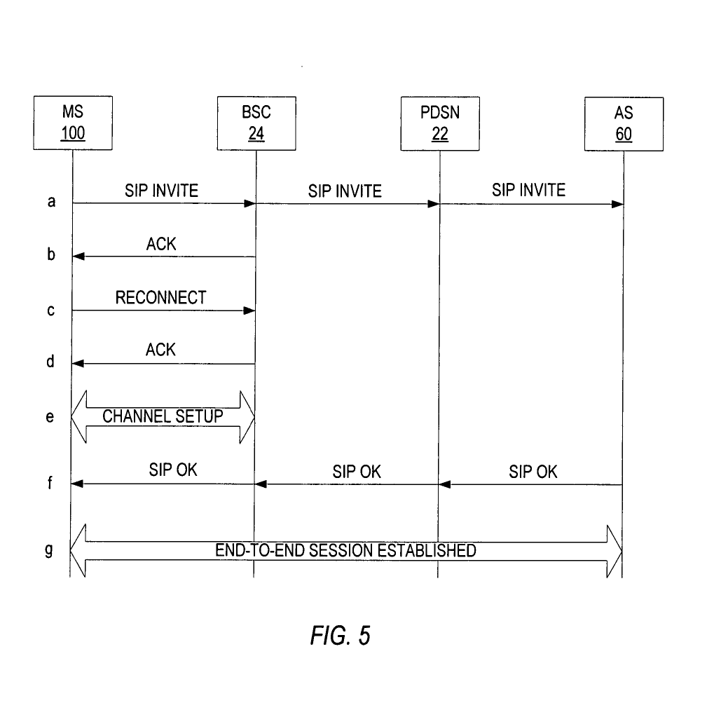

User interface 140 comprises one or more input devices 142 and a display 144. The input devices may comprise a keypad, joy stick control, touch pad, dial or any other known type of input device. The illustrated embodiment of the mobile station 100 also includes a push-to-talk (PTT) switch 46, which is technically an input device but is shown separately in FIG. 5. The operation of the PTT switch 46 is described in more detail below. Display 144 may comprise a conventional LCD or may comprise a touch screen display that also serves as an input device 142.

Audio circuits 150 include audio processing circuits 152, microphone 154, and speaker 156. Audio processing circuits 152 include D-to-A converters to convert digitized audio to analog signals suitable for output to speaker 156, and analog-to-digital converters for converting analog input signals from microphone 154 to digitized audio suitable for input to the baseband processing and control circuits 120. Microphone 154 converts the user's speech and other audible signals into electrical audio signals, and speaker 156 converts analog audio signals into audible signals that can be heard by the user.

Application processor 160 runs installed user applications, such as personal information management (PIM) applications, email applications, and instant messaging applications. In the exemplary embodiment shown in FIG. 4, the applications executed by the application processor include a push-to-talk (PTT) application. PTT is a half-duplex voice service wherein users press and hold a key when they speak, similar to a walkie talkie. Unlike regular voice calls, which are full duplex, PTT allows only one user to speak at a time. A user requests the “floor” by pressing a PTT key and maintains control of the floor once obtained by holding the PTT key.

During a group PTT session, all users connect to a PTT server that performs floor control and media distribution. A PTT server is a type of application server 60. A mobile station 100 requests the floor from the PTT server, and the PTT server grants it to them one at a time. A user requests the “floor” by pressing the PTT switch and maintains control of the floor once obtained by holding the PTT switch. The mobile station 100 holding the floor sends media to the PTT server, which distributes the media to the remaining participants. RTP is used for transport of voice packets and RTCP is used for floor control.

To establish a PTT session, the mobile station 100 must establish a communication session with the PTT server. Signaling between the mobile station 100 and PTT server uses the Session Initiation Protocol (SIP) or other session controlled protocol. If SIP is used as the session control protocol (which is assumed for the remainder of this application), the mobile station 100 sends a SIP INVITE message to the PTT server to initiate the communication session. The PTT server returns a response message (SIP OK). Additionally, the mobile station 100 must have a physical channel for communication with the base station 50 over which voice traffic can be transmitted. If not already established, the mobile station 100 must establish a physical channel with the base station 50.

FIG. 5 is a call flow diagram illustrating an exemplary procedure for setting up a communication session with an application server 60, such as a PTT server. In this example, it is assumed that the mobile station 100 has established a PPP connection with the PDSN 32 and that the packet data session is currently in a dormant state. As is well-known to those skilled in the art, a mobile station 1000 with a dormant packet data session maintains a connection to the PDSN 32, but does not have a radio channel for communication with the base station 50. A mobile station 100 in a dormant state can reestablish a communication channel by sending a reconnect message to the base station 50. A reconnect message is a layer 3 message that is used in the cdma2000 standard to reestablish a communication channel for a packet data session that is dormant. In response to the reconnect message, the base station 50 will assign the mobile station 100 a new channel. A reconnect message is typically very short, and sometimes may comprises a single frame.

Referring back to FIG. 5, the mobile station 100 sends a SIP INVITE message or other call control message to the application server 60 (step a). The SIP INVITE message may be sent in a short data burst (SDB) message over the reverse access channel (R-ACH) or the reverse enhanced access channel (R-EACH). The base station 50 acknowledges the call control message (step b) and forwards the SIP INVITE towards the application server 60. After the call control message is acknowledged by the base station 50, the mobile station 100 sends a reconnect message to the base station 50 to request assignment of a communication channel (step c). The reconnect message is sent over the R-ACH or the R-EACH. The base station 50 acknowledges the reconnect message (step d) and begins a channel setup procedure to establish a traffic channel (step e). Meanwhile, the application server 60 sends a response (SIP OK) to the SIP INVITE message to the mobile station 100 which establishes a communication session (step f). Upon receipt of the SIP response message, the mobile station 100 may begin exchanging data with the application server 60 (step g).

In the procedure shown in FIG. 5, the mobile station 100 is required to send two messages over the R-ACH or the R-EACH to the base station 50 to set up a communication session—one to set up a communication session with the application server 60 and one to set up a communication channel with the base station 50. Further, it will be noted that the signaling messages for establishing the communication session with the application server 60 and for establishing the communication channel with the base station 50 are sent sequentially. In the procedure shown in FIG. 5, the mobile station 100 sends a call control message to the application server first and waits for the base station 50 to acknowledge the message before sending the reconnect message. This process could be reversed and the mobile station 100 could send the reconnect message first. In either case, it takes a finite period of time for the base station 50 to receive, process and respond to messages from the mobile station 100. Thus, each message introduces some delay into the session set up process. For some applications, such as Push-to-Talk, reducing this delay detracts from the user experience.

The present invention provides a new procedure for establishing a communication session with an application server 60 that reduces delays in setting up a communication session with an application server 60. The procedure may be used, for example, when the mobile station 100 already has a PPP connection to the PDSN 32. In this scenario, the mobile station 100 can initiate a channel setup procedure by sending a reconnect message to the base station 50 as previously described. It is assumed in this example that the mobile station 100 wants to establish a new communication session with an application server 60. According to the present invention, a SIP INVITE or other call control message for establishing a communication session with the application server 60 is encapsulated as a short data burst (SDB) message within the reconnect message sent to the base station 50. The reconnect message specified in the cdma2000 standard is modified to include a flag indicating the presence of a SDB message encapsulated within the reconnect message. Upon receipt of the reconnect message with an encapsulated SDB message, the BSC 24 extracts the SDB message from the reconnect message and forwards it to the PCF 22, which routes the SDB message to the appropriate PDSN 32. The BSC 24 would immediately begin the traffic channel setup procedure. Thus, the mobile station 100 sends only a single message over the R-RACH to the base station 50 to initiate both the set up of the communication session with the application server 60 and the set up of a traffic channel to bear user traffic for the communication session.

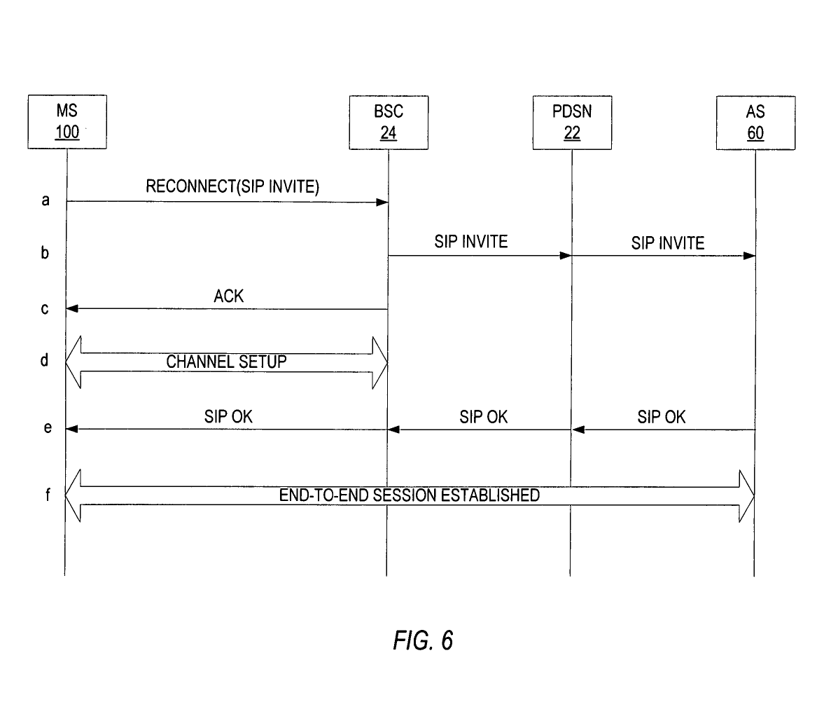

FIG. 6 is a call flow diagram illustrating the call setup procedure according to the present invention. The mobile station 100 sends a reconnect message to the BSC 24 to initiate channel setup (step a). The BSC 24 extracts the SDB message from the reconnect message and forwards the SDB message to the application server 60 (step b). At the same time, the BSC 24 sends an acknowledgment of the reconnect message to the mobile station 100 (step c) and assigns the mobile station 100 a traffic channel (step d). While the traffic channel is being set up, the application server 60 sends a SIP response (SIP OK) to the mobile station 100 to acknowledge the SIP INVITE message (step e). Upon receipt of the SIP response message from the application server 60, the communication session is established and the mobile station 100 and application server 60 can begin exchanging data (step f).

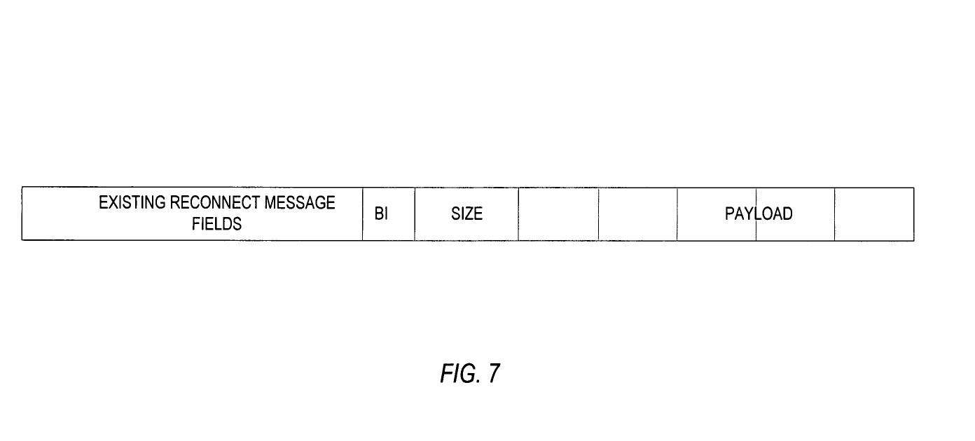

FIG. 7 illustrates the additional fields that need to be added to a conventional reconnect message as specified in the cdma2000 standard to practice the present invention. The additional fields added to the reconnect message include a burst indicator (BI) field, a size field, and a SDB payload field. The burst indicator field is a 1-bit flag indicating whether a SDB message is contained in the reconnect message. This field is set to “1” if a SDB message is included in the reconnect message and is otherwise set to 0. The size field indicates the size of the SDB payload. In one exemplary embodiment, the size field indicates the number of octets and the SDB payload. The SDB payload field is a variable length field containing the SDB message.

The present invention reduces the amount of time needed to initiate a communication session with an application server by allowing the set up of the traffic channel and the end-to-end communication session with the application server to proceed in parallel. The present invention may be beneficial when the mobile station has a dormant packet data session with the mobile network and can reestablish the communication channel by sending a reconnect message. Furthermore, the present invention reduces messaging on the R-ACH or R-EACH needed to establish a communication session with an application server.

1. A method of initiating a communication session between a mobile station and an application server, the method comprising:
sending a reconnect message from said mobile station to a base station to reestablish a communication channel for a dormant packet data session; and
encapsulating a call control message to said application server in said reconnect message.

2. The method of claim 1 wherein said call control message encapsulated within said reconnect message comprises a SIP request.

3. The method of claim 1 wherein said application server comprises a push-to-talk server.

4. The method of claim 3 wherein said call control message is to initiate a push-to-talk session with said push-to-talk server.

5. The method of claim 4 wherein said reconnect message is sent responsive to a page message.

6. The method of claim 5 wherein the call control message is contained within a short data burst.

7. The method of claim 6 wherein the reconnect message includes a burst indicator flag indicating the presence of a short data burst message in said reconnect message.

8. A mobile station for a wireless communication network comprising:
a transceiver for transmitting and receiving signals;
a control processor connected to said transceiver and operative to generate a reconnect message for transmission to a base station to reestablish a dormant packet data session, and to encapsulate within said reconnect message a call control message to an application server to initiate a communication session with said application server.

9. The mobile station of claim 8 wherein said call control message encapsulated within said reconnect message comprises a SIP request.

10. The mobile station of claim 8 wherein said application server comprises a push-to-talk server.

11. The mobile station of claim 10 wherein said call control message is to initiate a push-to-talk session with said push-to-talk server.

12. The mobile station of claim 11 wherein said reconnect message is sent responsive to a page message.

13. The mobile station of claim 8 wherein the call control message is contained within a short data burst.

14. The mobile station of claim 13 wherein the reconnect message includes a burst indicator flag indicating the presence of a short data burst message in said reconnect message.

15. A method of initiating a communication session between a mobile station and an application server, the method comprising:
receiving a reconnect message from a mobile station, said reconnect message containing a call control message from a mobile station to an application server; and
extracting said call control message from said reconnect message.

16. The method of claim 15 further comprising forwarding said call control message toward said application server.

17. The method of claim 16 further comprising reestablishing a communication channel with said mobile station for a dormant packet data session responsive to said reconnect message.

18. The method of claim 15 wherein said call control message contained within said reconnect message comprises a SIP request.

19. The method of claim 15 wherein said application server comprises a push-to-talk server.

20. The method of claim 19 wherein said call control message is to initiate a push-to-talk session with said push-to-talk server.

21. The method of claim 15 wherein said reconnect message is sent responsive to a page message from said base station.

22. The method of claim 15 wherein the call control message is contained within a short data burst.

23. The method of claim 22 wherein the reconnect message includes a burst indicator flag indicating the presence of a short data burst message in said reconnect message.

24. A base station for a wireless communication network comprising:
a transceiver for transmitting and receiving signals;
a control processor connected to said transceiver and operative to extract an embedded call control message from a mobile station to an application server from a reconnect message.

25. The base station of claim 24 wherein the control processor is further operative to forward said call control message toward said application server.

26. The base station of claim 25 wherein said control processor is further operative to reestablish a communication channel with said mobile station for a dormant packet data session.

27. The base station of claim 24 wherein said call control message encapsulated within said reconnect message comprises a SIP request.

28. The base station of claim 24 wherein said application server comprises a push-to-talk server.

29. The base station of claim 28 wherein said call control message is to initiate a push-to-talk session with said push-to-talk server.

30. The base station of claim 24 wherein said reconnect message is sent responsive to a page message.

31. The base station of claim 24 wherein the call control message is contained within a short data burst.

32. The base station of claim 31 wherein the reconnect message includes a burst indicator flag indicating the presence of a short data burst message in said reconnect message.
